(19) United States
(12) Patent Application Publication
(10) Pub. No.: US 2020/0145373 A1
(43) Pub. Date: May 7, 2020

(54) SYSTEM FOR BLOCKCHAIN BASED DOMAIN NAME AND IP NUMBER REGISTER

(71) Applicant: HAVENTEC PTY LTD, Sydney, New South Wales (AU)

(72) Inventor: Ric B. RICHARDSON, Coopers Shoot, New South Wales (AU)

(73) Assignee: HAVENTEC PTY LTD, Sydney, New South Wales (AU)

(21) Appl. No.: 16/616,019

(22) PCT Filed: May 22, 2018
(86) PCT No.: PCT/AU2018/050495

§ 371 Date: Nov. 22, 2019

(30) Foreign Application Priority Data
May 22, 2017 (AU) 2017901939

(51) Int. Cl. H04L 29/12; H04L 9/06; H04L 9/32

(52) U.S. Cl. CPC H04L 61/302; H04L 9/3236; H04L 61/1511; H04L 9/0637

(57) ABSTRACT

A method of managing domain names and IP addresses over a network the method including generating, securing, transferring, registering, updating, and using of the domain names and IP addresses on at least one network device participating in a blockchain.

### BACKGROUND

Domain name services are well known in the art. Typically they comprise a publicly accessible database of domain names and their related current IP numbers. Typically these databases are only modifiable or updated by trusted parties such as verified domain name registry's. These services are essential to the operation of the Internet because access to an online service by anyone on the Internet is dependent on the enquiring device being able to obtain the current IP number of a specific domain before the services on that domain can be connected to, accessed and used.

A problem has arisen that has severely impacted the operational reliability and dependability of the current structure of domain name servers because of a series of distributed denial of service (DDoS) attacks. This occurred when key domain name servers were flooded with data from hundreds and thousands of hacked devices and the ability for third parties to access the domain name servers was impacted for many hours or not available at all.

This led to inconvenience and commercial loss for many Internet users but more importantly impacted the ability for critical online computing infrastructure from getting control information from online management systems around the Internet.

A large scale attack of this type could completely disable the Internet for large parts of a target country or region.

Methods being considered to address this problem include but are not limited to increasing the number of domain name servers available on the Internet.

Another open and proven trustworthy technology called blockchain has become known in the art for publishing verified and trustworthy information. The technology uses cross verification and a widely distributed network of identical copies of a shared ledger to stop manipulation of trusted transaction data. The largest known application of this technology is the transaction ledger or blockchain for BitCoin.

An adaptation of this trusted means of publishing critical data has not been used to date to distribute information about domain names and their current related IP address.

The described invention is designed to address this issue.

### NOTES

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### BRIEF DESCRIPTION OF INVENTION

Accordingly in one broad form of the invention there is provided a method of managing domain names and IP addresses over a network; said method comprising generating, securing, transferring, registering, updating and using of the domain names and IP addresses on at least one network device participating in a blockchain; generating a data record on a network device as an initiating device which has an initiating device unique identifier; the data record containing at least a first record and a first unique identifier record; the first record containing data for transmission over the network to a device having a receiving device unique identifier; the first unique identifier record containing the initiating device unique identifier; storing the data record in all network devices participating in a blockchain for securing and using transmitting the data record to the second network device for registration at the second network device; verifying the data record at the second network device for existence and credentials in the blockchain; registering the data record at the second network device for subsequent reuse of the data record in the blockchain; transmitting the registered data record to all network devices in the blockchain.

Preferably, the method further including defining a special user which has a specific role in the network in that it has the capability of initially linking a specific domain name to a specific IP number and adding this information as part of a transaction to a blockchain ledger in the blockchain.

In yet another broad form of the invention there is provided a system of managing domain names and IP addresses over a network;

said system incorporating a server which generates, secures, transfers, registers, updates and uses of the domain names and IP addresses on at least one network device participating in a blockchain on the network;
said system further including a processor and memory which generates a data record on a network device as an initiating device which has an initiating device unique identifier; the data record containing at least a first record and a first unique identifier record; the first record containing data for transmission over the network to a device having a receiving device unique identifier; the first unique identifier record containing the initiating device unique identifier;
storing the data record in all network devices participating in a blockchain for securing and using
transmitting the data record to the second network device for registration at the second network device;
verifying the data record at the second network device for existence and credentials in the blockchain;
registering the data record at the second network device for subsequent reuse of the data record in the blockchain;
transmitting the registered data record to all network devices in the blockchain.

Preferably, the system further including defining a special user which has a specific role in the network in that it has the capability of initially linking a specific domain name to a specific IP number and adding this information as part of a transaction to a blockchain ledger in the blockchain.

In yet another broad form of the invention there is provided a media storing code which when executed by a processor performs the method as described above.

### BRIEF DESCRIPTION OF DRAWINGS

Embodiments of the present invention will now be described with reference to the accompanying drawings wherein:

FIG. 1 Main components of the example embodiment,

FIG. 2—System initiation of the example embodiment,

FIG. 3—Block diagram illustrates the mining process to be used in the example embodiment,

FIG. 4—Block diagram illustrates steps to access the DNS blockchain,

FIG. 5—Diagram of an exemplary block chain data structure,

FIG. 6 illustrates diagrammatically use of the block chain data structure of FIG. 5.

### DESCRIPTION OF OPERATION

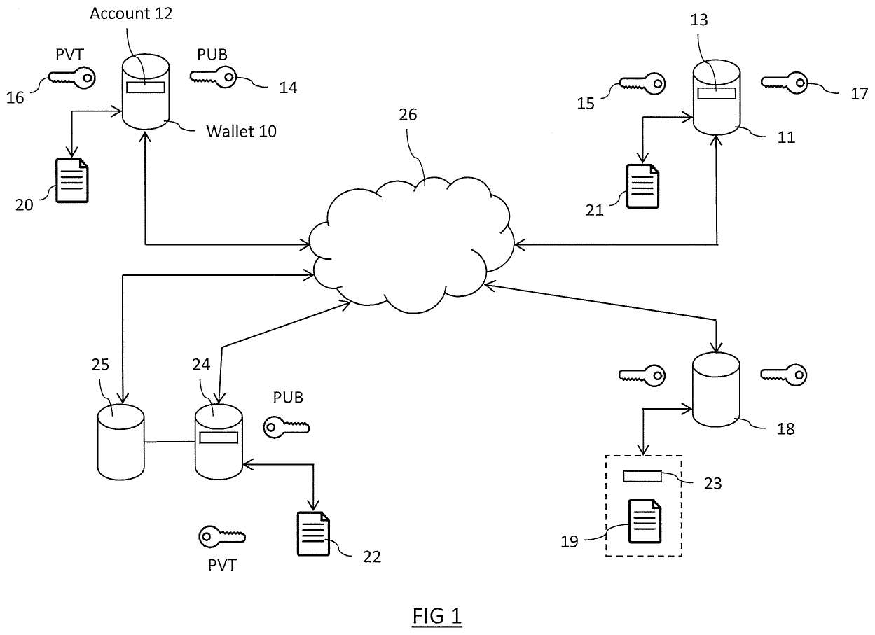

FIG. 1 discloses the main components of the example embodiment. The example embodiment comprises all the main components of a standard Bitcoin network with some additional capabilities and rules of operation.

Like a traditional BitCoin network the example embodiment includes users who have wallets 10 11. Each user's wallet contains at least one or more accounts 12 13. Each account 12 13 has a corresponding public key 14 15 and private key 16 17. The public key in each case 14 15 is used to identify the account being addressed 12 13 and as part of a verification and security technique called public key encryption that utilises each user's account 12 13 by using the accounts private key 16 17 to prove that the user is the owner of the account.

The system also includes a processing service called a mining computer 18 which is used to add transactions 23 to a universal ledger 19 20 21 22 or blockchain which is then shared on a peer to peer basis across the Internet 26 to other user's 10 11 18 24.

The above system design is known in the art but has been duplicated here for clarity since the proposed system of the example embodiment uses the same structure with additional capabilities and modifications.

Unlike a standard Bitcoin network, the example embodiment includes a special class of user 24. This special user would typically be an existing domain name registrar 25 that is currently used to verify ownership and identity of domain name owners 10 11. This special user has a specific role in the network in that it has the capability of initially linking a specific domain name to a specific IP number and adding this information as part of a transaction to the blockchain ledger.

In a traditional Bitcoin transaction, a user 12 will credit another user's account 13 on the blockchain using a deduction from their own account 12 with their own public key 14 as the identifier, and then credit the recipient's account using the recipient's public key 15. In the case of the example embodiment the same process happens except that there are two additional pieces of information included in the transaction information.

Since the purpose of the transaction is to transfer ownership of a domain or to update the IP number associated with a domain, each transaction will include not only the identity of the sender, the identity of the receiver and a transaction amount, but also the name of the domain being transacted and the IP number to be associated with the domain name as a result of the transaction.

It is also important to note that the amount of the transaction is not material to the transaction as the monetary value of the transaction may be negotiated and administered separately.

To clarify, in a traditional Bitcoin network transaction, each transaction comprises a number of Bitcoins or subdivisions of a Bitcoin known in the art as Satoshi's. In the example embodiment, a minimum unit of transfer such as a Satoshi could be used to move ownership from one user to another or to update an IP number for a specific domain. In the application envisaged of the example embodiment a Satoshi would represent one unit of transaction token and one token could be used to transfer ownership or update an IP number for a given domain name.

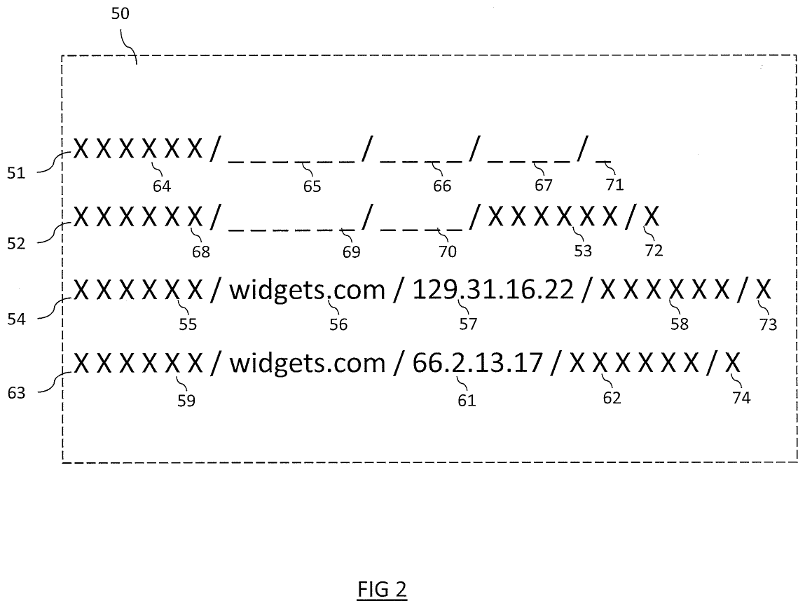

This process initialises the domain name as part of the domain name ledger. The domain name ledger 20 21 19 22 is the equivalent of a standard ledger blockchain in a Bitcoin network with the addition of data relating to a domain name and IP number. This functionality is explained in more detail in FIG. 2.

As explained in detail in FIG. 2, the shared ledger 19 20 21 22 of the example embodiment system not only includes traditional Bitcoin type transaction information but will also contain domain names and related current IP numbers.

In a traditional Bitcoin network, the owner of a mining computer system 18 is paid for their processing work with a system wide grant and agreed price of additional Bitcoins as compensation for the computing time and effort undertaken by the mining system in processing and verifying new transactions on behalf of other members of the network.

In the case of the example embodiment however mining services are not paid for in Bitcoin, but rather they are paid for as an independent service. In the case of the example embodiment the Bitcoin that is generated from the mining process does not have a system wide value until the coin is transferred to a special registry user 24 and a domain name and IP number are bound to that transaction.

In the example embodiment the price paid for mining services will be paid at market prices commensurate with the costs involved with administering domain names and registry processes in today's non-blockchain based market.

FIG. 2 discloses a simplified example of the blockchain ledger data 50 that would be contained in the example embodiment. For purposes of clarity and simplification only transactions relating to one specific domain name are shown 50.

A typical blockchain ledger will include information about the sending user, the receiving user and the amount being transacted amongst other data pieces used to verify and authenticate the parties and data being transacted.

In the case of the example embodiment the blockchain ledger 50 contains a number of example transactions 51 52 54 63 to illustrate various types of transactions possible using the example embodiment.

When the system generates bitcoin tokens using the mining process, these are typically credited to the account of the mining computers user identity 64. In this case it would be the public key of the mining computers user account. Since there is no domain name associated with the transaction there is no domain name recorded, no related IP number recorded 66 and no second party identity since the system credits the mining user due to the work they have undertaken to add blocks of transaction information to the blockchain. The system credits the mining user with a predetermined number of tokens 71 as is normal with a standard Bitcoin network.

In the example embodiment, the mining user 64 must transfer 52 their transaction tokens 71 to a special registry user 68 in order to be compensated for their work. With this first transfer 52 the data recorded includes the miners public key 68 and the special registry user's public key 53, but no domain name 69 or IP number 70 are recorded as part of the transaction. This type of transaction 52 is used primarily to supply the special registry user with transaction tokens 72 for use in subsequent transactions.

After the special registry user has verified the identity and ownership of a domain user, the special registry user 55 can transfer custody of a domains 56 ownership to a specific user 58 with a transaction 54 of minimum value 73. During this transfer 54, the special registry user can also define the IP number 57 to be associated with the domain 56 from that time forward until the next transaction legitimately occurs in relation to the subject domain.

When an owning user 59 wants to subsequently transfer ownership of a domain 63 to another user 62 the new owner 62 must specify the IP number 61 they wish to have used and the transaction 63 is added to the blockchain including the seller's public key 59, the domain name involved 60, the related IP number to be used for the domain 61 and the public key of the new owner 62. For the transaction to occur a minimal transaction amount such as one token 74 could be used.

If the user 59 simply wants to change the IP number 61 of a domain 60 they already own, then the user could simply generate a new account and related public key 62 for their own wallet and change the IP number 61 as they transact with a different account that they themselves own.

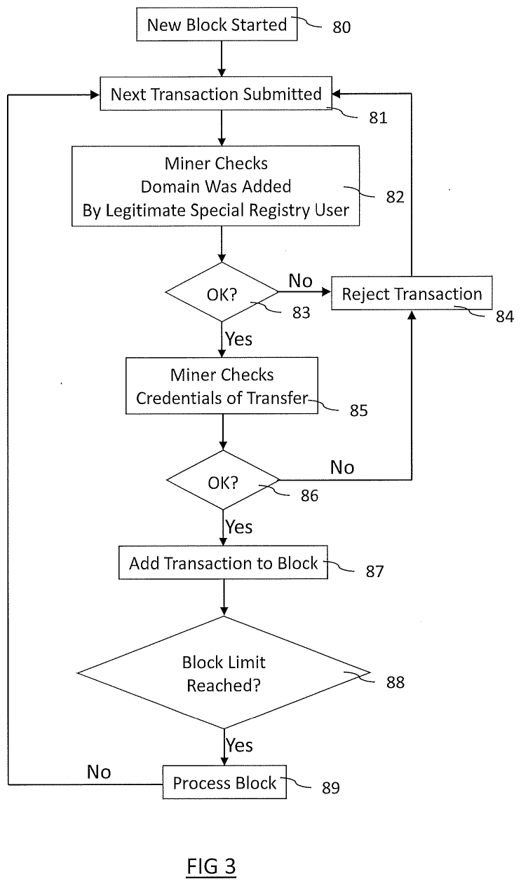

FIG. 3 discloses the mining process to be used in the example embodiment. It is different from a standard Bitcoin mining process in that domain names and related IP numbers are added to the block chain as part of the recorded and verified data, but also because the heritage of each domain name is checked before it is added to the blockchain.

When a new block is to be built and added to the blockchain 80 the next transaction to be included in the block is presented for verification and inclusion 81. Next the mining software checks that the domain that is mentioned as part of the transaction was added at some time in the past by a legitimate special registry user 82 or that the transaction is being requested by a special registry user. If the check fails the transaction is rejected 84 and the next transaction is processed 81.

If that test is passed 83 then the Miner cryptographically checks the credentials of the transferrer 85. If that test is passed then the transaction is added to the block 87. If it not passed then the transaction is rejected 84 and another transaction processed 81. When a transaction is added to a block 82 the system determines if the block limits have been reached 88. If not then the next transaction is processed 81. If a limit has been reached the block is processed 89.

With this process, the system miner ensures that the integrity of domain names and related IP numbers remains intact from the time they are first added to the DNS blockchain by a legitimate special registry user.

This process also means that users have to do minimal checking of blockchain integrity when using the blockchain for their own DNS lookup services.

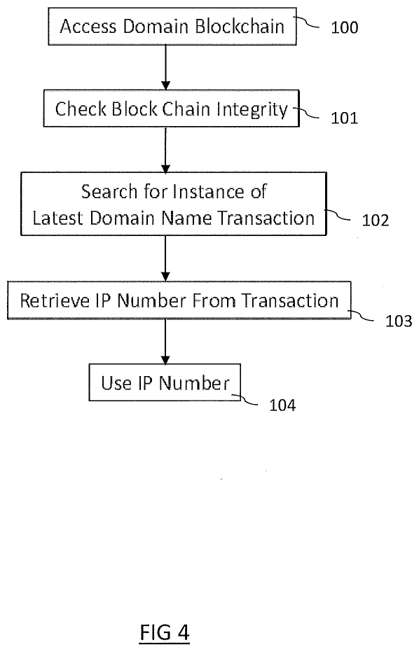

FIG. 4 discloses how a client device such as a smartphone using a browser would access the DNS blockchain to determine the latest current IP number for a specific domain name. A smartphone could contain a browser application with its own current copy of the DNS blockchain. To find the related IP number for the requested domain name, the browser would access the domain blockchain 100 and check the blockchain for its integrity 101 using known and practised cryptographic tests currently known in the art for blockchain applications.

Then the browser could search back from the latest block of data to older blocks looking for the latest instance of a transaction involving the requested domain 102. Then the corresponding IP number would be retrieved 103 and the IP number used to connect with the target computer 104.

The result is a DNS database that is reliable, current and so widely distributed so as to be impervious to large scale distributed denial of service attacks.

### Block Chain Structures

Blockchain structures may be used to advantage with any of the above described embodiments.

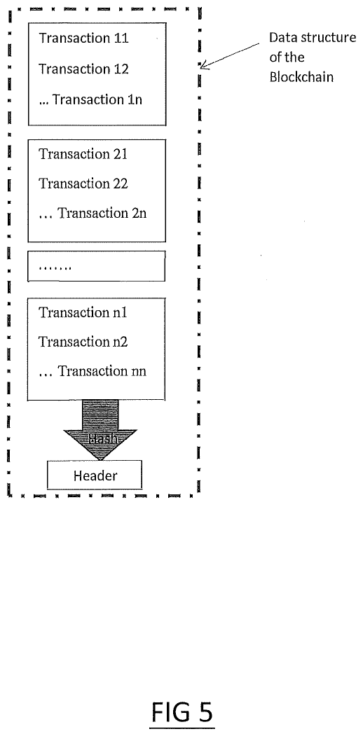

FIG. 5 is a diagram of an exemplary block chain data structure.

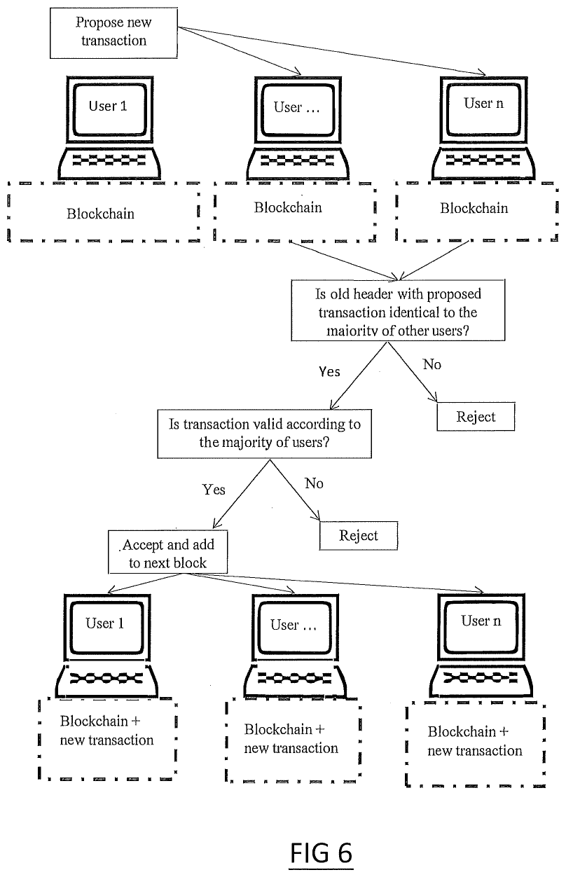

FIG. 6 illustrates diagrammatically use of the block chain data structure of FIG. 5.

With reference to FIGS. 5 and 6, Blockchain is a data structure and distributed record system, which seeks to provide a data structure and system which maintains a complete record of all transactions and minimizes risk of retrospective alterations, or double or identical transactions.

The data structure consists of a series of transactions grouped in blocks, which need to be verified before they are added to the chain. Rules may be set so no data is ever deleted, with the longest chain being taken to be the most recent, and so the chain records all transactions from its initiation in chronological order.

A copy of the chain is kept by all users, and so is a distributed record system. Before any transactions are added the majority of the users need to agree that the transaction is acceptable and then it is bundled with other acceptable transactions into a block, which is added to the chain. Each block has a header which can only be created knowing all the previous transactions. As a result, if a retrospective alteration is made the header will be incorrect and any new block proposed by that user will be rejected. The security of the system is further enhanced by having mathematical problems that can only be solved by trial and error, which use the header and must be solved and then verified by the majority of other users before a block is accepted into the chain by all users. As long as there are more genuine users than coordinated attackers trying to alter the chain then the chain will be secure. There may be other methods used to determine the veracity of a block of data, this may include voting or consent processes where parties with a stake in the transaction or related transactions or in the chain itself are granted ‘voting’ rights. Another process may involve a random or systematized voting or approval system where the validity of the block of data is approved in accordance with a set of protocols agreed by those with a stake in the veracity of the chain of data.

In a more particular form, each block includes verified transactions and the blockchain maintains a ledger all prior transactions. The blockchain is duplicated by all the computers on a network.

The first block in the chain is known as the Genesis block and new blocks can be added in linear and chronological order. From any given block in the chain the information of this genesis block and all blocks that led back to this one can be retrieved. A blockchain is essentially numerous blocks connected through hash chaining where each block is comprised of the following

Timestamp: provides proof that the data in a block existed at a particular time
Previous Hash: Essentially a pointer to the previous block
Merkle Hash: Summary of all executed transactions
Nonce: Individual blocks identity and is an arbitrary number which can only be used once

The blockchain is managed by a network of distributed nodes where each node contains a copy of the entire blockchain. Each node in the network can add blocks to the chain, where every node is adding blocks at the same point in the chain at the same time. The more nodes that comprise the network the harder it is to disrupt the storage of the blockchain. Unlike centralised systems which rely on a single authority, there is no single point of failure in these distributed nodes network. If you change the content of a block you change its Hash.

### ALTERNATIVE EMBODIMENTS

The example embodiment uses a cryptographically sealed blockchain ledger that is managed and built using the main components of the existing Bitcoin cryptocurrency system. An alternative embodiment could use any type of public ledger or blockchain system that uses public key signing and authentication to verify the ownership, chain of custody, veracity and trustworthiness of the ownership of every domain name stored in its data structure.

The example embodiment uses a minimal transaction amount called a token as part of each transaction that verifies a transfer of ownership or a change of IP number. The example embodiment utilises a token system that is the equivalent of one Satoshi in the Bitcoin cryptocurrency system. An alternative embodiment could use a variable price token system so that each transaction could also include a transfer price as part of the transaction data recorded.

The example embodiment shows that blockchain miners generate tokens that are traded for generated income when transferred to a special registry user for use in the domain name registration and IP number binding process. In an alternative embodiment tokens could be used in a credit system that allows the miners to be compensated directly by the network for their mining work. For example a miner could be allocated a domain and IP number by a special registry user in return for their mining work and then on sell that domain to third parties as a profit.

The example embodiment does not integrate an identity verification and publishing system. An alternative embodiment could include a wallet that has an integrated identity verification system that will allow 3rd parties and second parties to verify the user's identity beyond the published public key to include information such as the owner's name, address and contact details. The example embodiment assumes that this information is still managed and verified by the registries of domains as a service that they currently undertake and offer.

The example embodiment anticipates but does not specifically require that domain owners will want to and would transfer ownership of owned domain directly to second parties if and when they wish to sell or transfer their ownership and rights. An alternative embodiment could see the addition of a rule in the operating software and system that the domain owner must transfer their domain by means of an initial transfer to a recognised special registry user with a request to transfer the domain onto the desired receiving party. This process may be desirable if identity verification is required by local laws before a transfer of domain can legally take place or where domain ownership restrictions require such a step.

The example embodiment shows that the IP number to be used in a transfer should be specified before the transfer of a domain from one user to another. In an alternative embodiment the seller could transfer the domain to a new user using the existing or other IP number and then the new owner could update the IP by registering the new IP number on the block chain with a transfer between accounts in the user's own wallet.

1. A method of managing domain names and IP addresses over a network;
said method comprising generating, securing, transferring, registering, updating and using of the domain names and IP addresses on at least one network device participating in a blockchain;
generating a data record on a network device as an initiating device which has an initiating device unique identifier; the data record containing at least a first record and a first unique identifier record; the first record containing data for transmission over the network to a device having a receiving device unique identifier; the first unique identifier record containing the initiating device unique identifier;
storing the data record in all network devices participating in a blockchain for securing and using;
transmitting the data record to the second network device for registration at the second network device;
verifying the data record at the second network device for existence and credentials in the blockchain;
registering the data record at the second network device for subsequent reuse of the data record in the blockchain;
transmitting the registered data record to all network devices in the blockchain.

2. The method of claim 1, the method further including defining a special user which has a specific role in the network in that it has the capability of initially linking a specific domain name to a specific IP number and adding this information as part of a transaction to a blockchain ledger in the blockchain.

3. A system of managing domain names and IP addresses over a network;
said system incorporating a server which generates, secures, transfers, registers, updates and uses of the domain names and IP addresses on at least one network device participating in a blockchain on the network;
said system further including a processor and memory which generates a data record on a network device as an initiating device which has an initiating device unique identifier; the data record containing at least a first record and a first unique identifier record; the first record containing data for transmission over the network to a device having a receiving device unique identifier; the first unique identifier record containing the initiating device unique identifier;
storing the data record in all network devices participating in a blockchain for securing and using;
transmitting the data record to the second network device for registration at the second network device;
verifying the data record at the second network device for existence and credentials in the blockchain;
registering the data record at the second network device for subsequent reuse of the data record in the blockchain;
transmitting the registered data record to all network devices in the blockchain.

4. The system of claim 3, the system further including defining a special user which has a specific role in the network in that it has the capability of initially linking a specific domain name to a specific IP number and adding this information as part of a transaction to a blockchain ledger in the blockchain.

5. Media storing code which when executed by a processor performs the method of claim 1.

6. A method for ensuring that the integrity of domain names and related IP numbers remains intact from the time they are first added to a DNS blockchain by a legitimate special registry user; the method comprising the steps of:
when a new block is to be built and added to the DNS blockchain the next transaction to be included in the block is presented for verification and inclusion;
a mining software checks the domain name that is mentioned as part of the transaction which was added at some time in the past by the legitimate special registry user or that the transaction is being requested by a special registry user;
if the mining software check fails the transaction is rejected and the next transaction is processed;
if the mining software check is passed then the system conducts a credentials test wherein the system cryptographically checks credentials of transferrer of the transaction;
if the credentials test is passed then the transaction is added to the block;
if the credentials test is not passed then the transaction is rejected and another transaction is processed.

7. The method of claim 6 wherein when a transaction is added to the block the system determines if block limits have been reached;
if the block limits have not been reached then the next transaction is processed;
if the block limits have been reached then the block is processed.
